(19) United States
(12) Patent Application Publication
(10) Pub. No.: US 2019/0385207 A1
(43) Pub. Date: Dec. 19, 2019

(54) TICKETING SYSTEM AND METHOD

(71) Applicants: Paul Penney, Redondo Beach, CA (US); David Raber, Laguna Beach, CA (US)

(72) Inventors: Paul Penney, Redondo Beach, CA (US); David Raber, Laguna Beach, CA (US)

(21) Appl. No.: 15/570,908

(22) PCT Filed: Oct. 31, 2017
(86) PCT No.: PCT/US17/59231

§ 371 Date: Oct. 31, 2017

Related U.S. Application Data
(60) Provisional application No. 62/415,630, filed on Nov. 1, 2016.

(51) Int. Cl. G06Q 30/06; G06Q 20/32; G06Q 10/02; G07B 1/00

(52) U.S. Cl. CPC G06Q 30/0621; G06Q 30/0641; G07B 1/00; G06Q 10/02; G06Q 20/322

(57) ABSTRACT

A ticketing system may include a computer-server and a user-interface in communication with the computer-server. The system may also include a selection-module in communication with the computer-server that enables a user via the user-interface to select an event and a user-selected-association related to the event. The system may further include a generation-unit in communication with the computer-server to produce a souvenir of the event and the user-selected-association authorized by an event promoter.

### RELATED APPLICATION

This application is based upon, and claims priority from, co-pending Provisional Application No. 62/415,630, filed Nov. 1, 2016, the entire subject matter of which is incorporated herein by reference in its entirety.

### BACKGROUND

The embodiments relate to the field of ticketing systems.

Generally, a ticket is a receipt that entitles admission to an event or establishment, passage with a travel provider, and/or the like. The ticket may also provide reservation of a seat and/or area along with the general admission.

### SUMMARY

According to an embodiment, a system may include a computer-server and a user-interface in communication with the computer-server. The system may also include a selection-module in communication with the computer-server that enables a user via the user-interface to select an event and a user-selected-association related to the event. The system may further include a generation-unit in communication with the computer-server to produce a souvenir of the event and the user-selected-association authorized by the event promoter.

The souvenir may be a physical ticket that the generation-unit prints. The generation-unit may print an image selected by the user on the physical ticket.

The image may include classic game tickets, special game moments, and/or personalized photo. The selection-module may enable the user to select data about their attendance at the event.

The data may include scan my printed ticket, upload my electronic ticket, and/or my dog ate my ticket. The data may include standard souvenir ticket and authentic validated ticket.

The system may additionally include a payment-module on the user-interface that the user uses to pay for the souvenir. The user-interface may execute on a user's mobile phone application, a webpage, and/or team's/act's mobile application.

Another aspect is a method that may include selecting an event and a user-selected-association related to the event via a user-interface executing a selection-module. The method may also include producing a souvenir of the event and the user-selected-association authorized by the event promoter via a generation-unit based upon the selected event and user-selected-association. The method may further include printing a physical ticket by the generation-unit. The method may additionally include printing an image selected by the user on the physical ticket.

The method may also include selecting data about user's attendance at the event via the selection-module. The method may further include providing a payment-module on the user-interface that the user uses to pay for the souvenir. The method may additionally include executing on a user's mobile phone application, a webpage, and/or team's/act's mobile application the user-interface.

Another aspect is computer readable program codes coupled to tangible non-transitory media to provide ticketing. The computer readable program codes may be configured to cause the program to select an event and a user-selected-association related to the event via a user-interface executing a selection-module; and to produce a souvenir of the event and the user-selected-association authorized by the event promoter via a generation-unit based upon the selected event and user-selected-association.

The computer readable program codes may further provide printing a physical ticket by the generation-unit. The computer readable program codes may additionally provide printing an image selected by the user on the physical ticket.

The computer readable program codes may also provide selecting data about user's attendance at the event via the selection-module. The computer readable program codes may further provide providing a payment-module on the user-interface that the user uses to pay for the souvenir.

### BRIEF DESCRIPTION OF THE DRAWINGS

FIG. 1 is a schematic block diagram of a system in accordance with the embodiments.

FIG. 2 is a flowchart illustrating method aspects according to various embodiments.

FIG. 3 is a flowchart illustrating method aspects according to the method of FIG. 2.

FIG. 4 is a flowchart illustrating method aspects according to the method of FIG. 3.

FIG. 5 is a flowchart illustrating method aspects according to the method of FIG. 2.

FIG. 6 is a flowchart illustrating method aspects according to the method of FIG. 2.

FIG. 7 is a flowchart illustrating method aspects according to the method of FIG. 2.

FIG. 8 shows the difference between a low quality/dispensable and a souvenir in accordance with the embodiments of FIG. 1.

FIG. 9 is the first half of an exemplary process of ordering the ticket souvenir in accordance with the embodiments of FIG. 1.

FIG. 10 is the second half of an exemplary process of ordering the ticket souvenir in accordance with the embodiments of FIG. 9.

FIG. 11 shows the addition of a personalized photo to the souvenir in accordance with the embodiments of FIG. 1.

FIG. 12 shows an example of a special game moment in accordance with the embodiments of FIG. 1.

FIG.13 shows an example of a classic style replica moment in accordance with the embodiments of FIG. 1.

FIG.14 illustrates scan my printed ticket in accordance with the embodiments of FIG. 1.

### DETAILED DESCRIPTION

Embodiments will now be described more fully hereinafter with reference to the accompanying drawings, in which preferred embodiments are shown. Like numbers refer to like elements throughout.

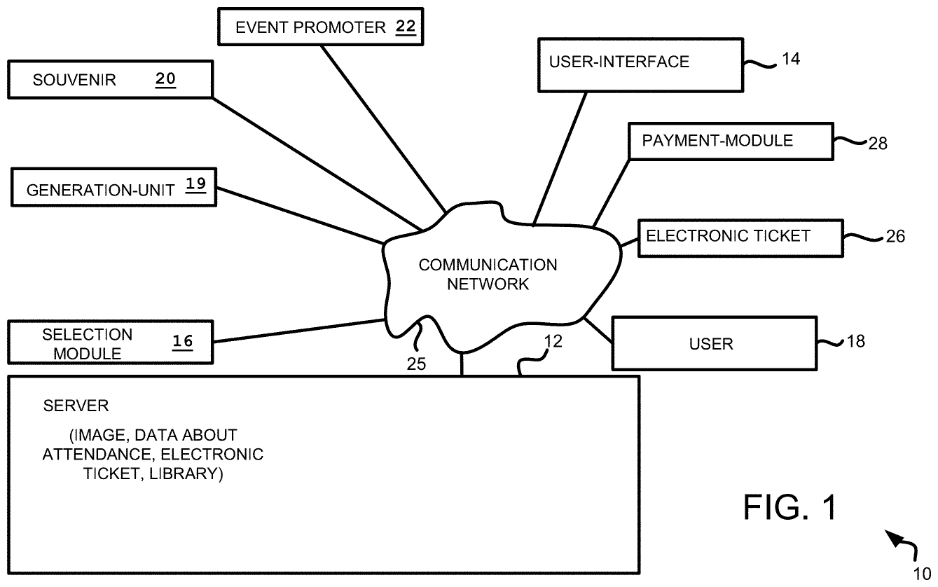

With reference now to FIG. 1, a ticketing system 10 is initially described. In one embodiment, the system 10 includes a server 12, e.g. a computer processing device such as a computer program, computer, tablet computer, smart phone, bar code scanner, radio frequency scanner, and/or the like. The system 10 also includes a user-interface 14 in communication with the computer-server 12. The system also includes a selection-module 16 in communication with the computer-server 12 that enables a user 18 via the user-interface 14 to select an event and a user-selected-association related to the event. A user-selected-association related to the event is a picture, graphic, written text, and/or the like, for example.

The system further includes a generation-unit 19 in communication with the computer-server 12 to produce a souvenir 20 of the event and the user-selected-association authorized by an event promoter 22. The generation-unit 19 is a printer local to the user 18 and/or a printer remote from the user, for instance. In an alternative embodiment, the generation-unit 19 generates an electronic souvenir 20.

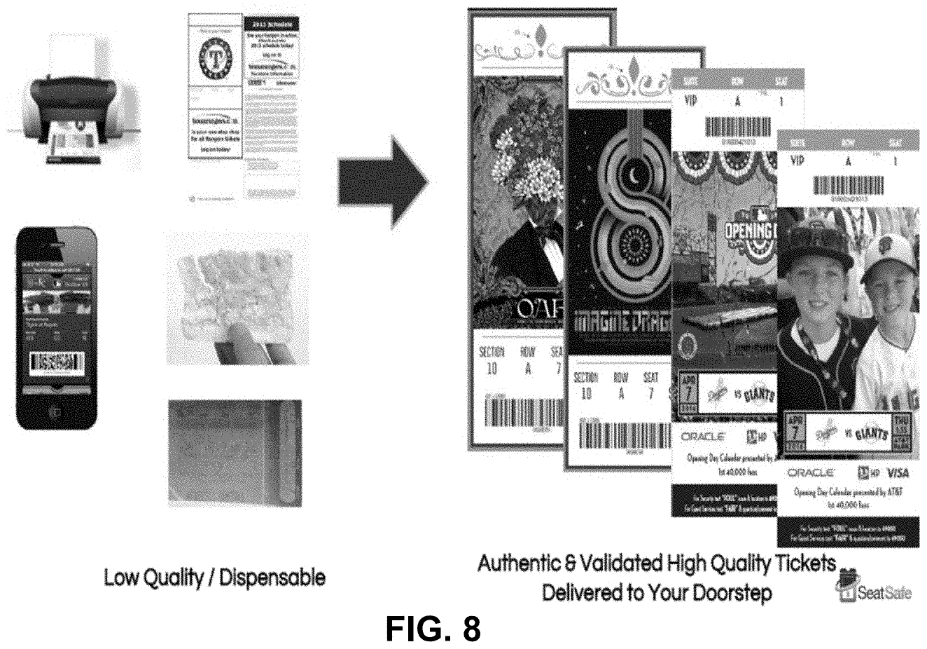

For instance, system 10 makes it simple for fans to order, own and cherish custom replica and authentic tickets, e.g. souvenir 20, from memorable games and events using the convenience of their smartphone. FIG. 8 shows the difference between a low quality/dispensable ticket and a souvenir 20 that is an authentic & validated ticket.

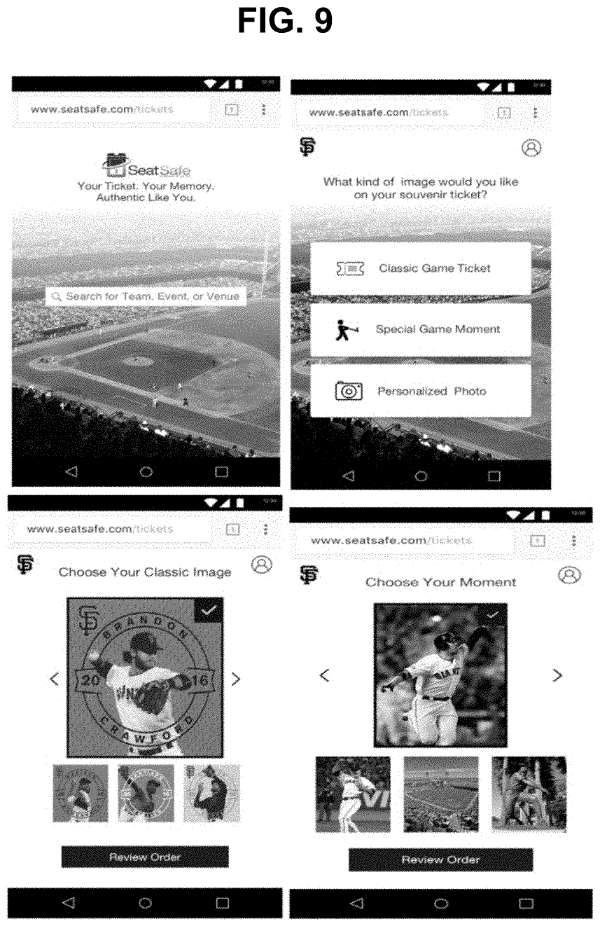

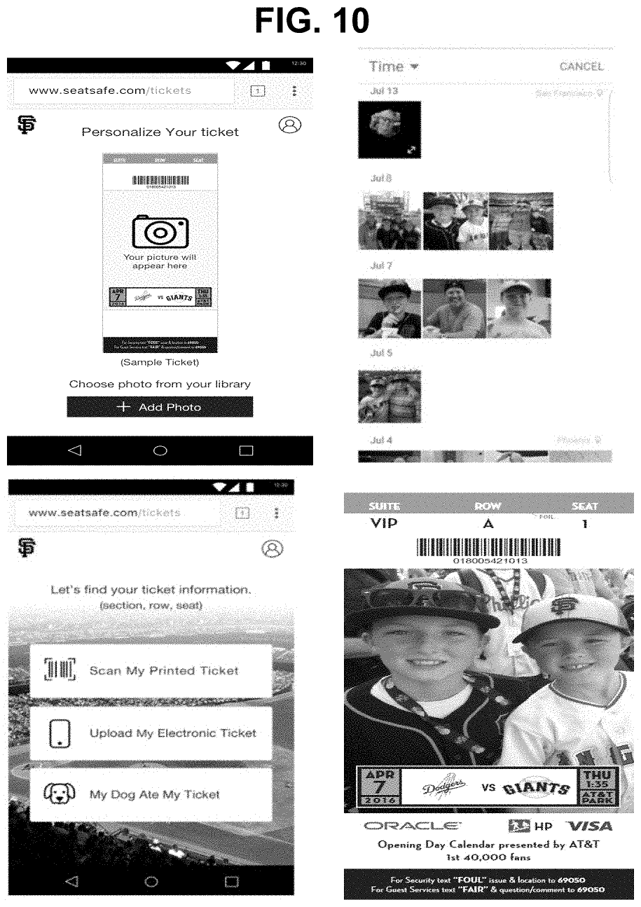

FIGS. 9 and 10 shows an exemplary process of ordering the ticket, e.g. souvenir 20. In one embodiment, the preferred flow for FIGS. 9 and 10 begins at upper left hand corner of FIG. 9, then proceeds to the right, then down to the lower left hand corner, and ends with souvenir 20 at the lower right hand corner of FIG. 10.

In one embodiment, the souvenir 20 is a physical ticket that the generation-unit 19 prints. In another embodiment, the generation-unit 19 prints an image selected by the user 18 on the physical ticket.

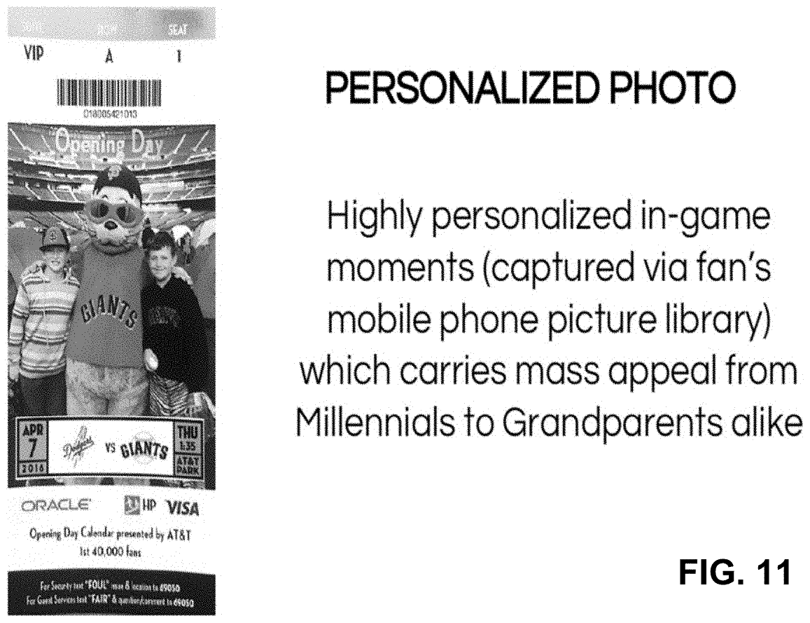

In one embodiment, the image includes classic game tickets, special game moments, and/or personalized photo. FIG. 11 shows the addition of a personalized photo to the souvenir 20.

In an alternative embodiment, a picture, graphic, written text, personalized photo, and/or the like, for instance, can be added to the ticket/souvenir 20 prior to the event so that the ticket/souvenir 20 can be given as a gift of attendance at the event, for example. In other words, a user 18 can customize the ticket, e.g. souvenir 20, which can be used to gain entry to an event.

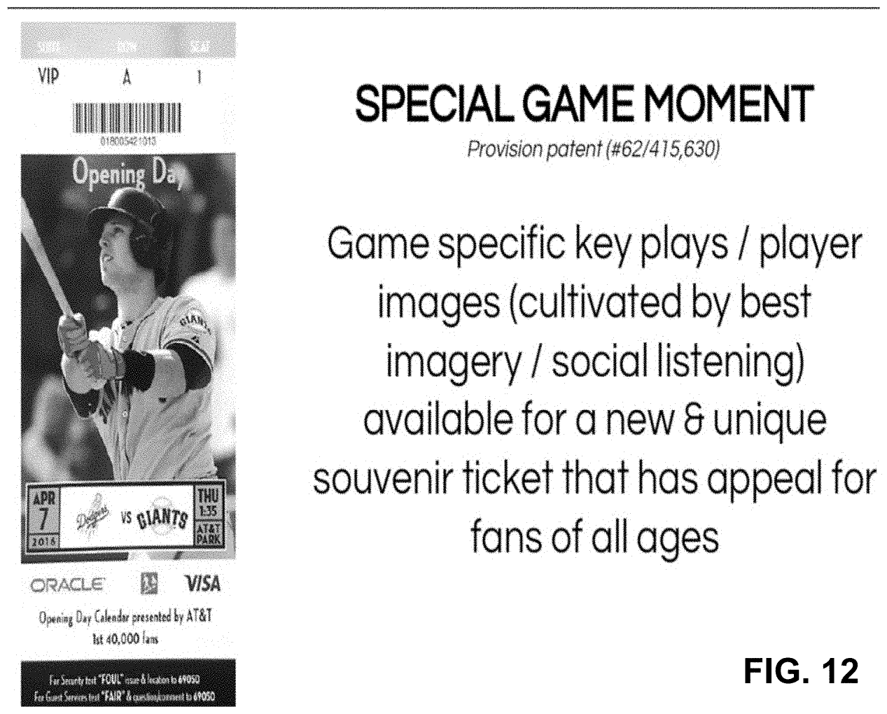

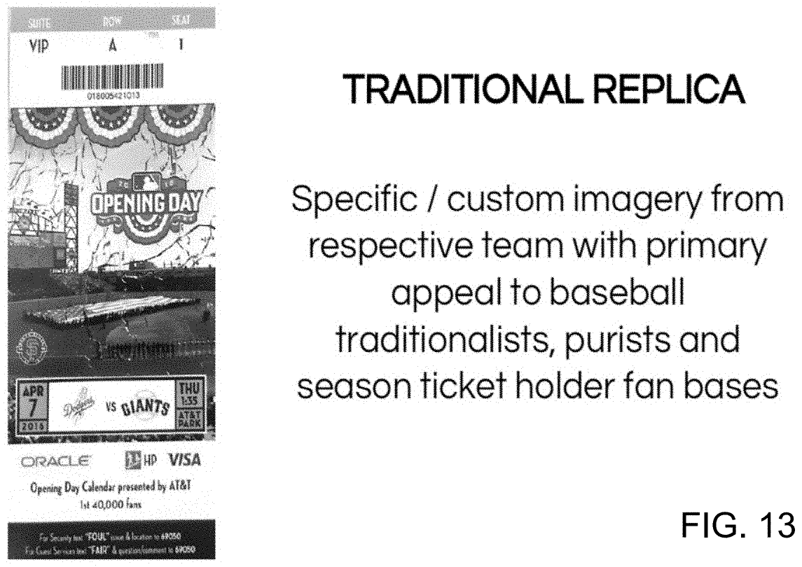

FIG. 12 shows an example of a special game moment. FIG. 13 shows an example of a classic style replica moment. In another embodiment, the selection-module 16 enables the user 18 to select data about their attendance at the event. The system 10 provides collectable keepsake, e.g. souvenir 20, that is lost with onslaught of digital ticketing, can give life to unused/event digital pictures, and can provide new limited edition item with intrinsic value that could evolve into collectable value. System 10 also provides new revenue streams to monetize existing PDF and/or mobile ticket purchases and/or upsell opportunities for ticket purchases or VIP bundles.

System 10 also provides a new product category that drives increased revenue and profits, direct marketing opportunities to actual event attendees for incremental concessions, merchandise and future event sales, and helps to maintain loyalty/enhance value to individual/season ticket holder base(s). System 10 also provides a way to monetize existing artwork beyond traditional items (i.e. posters or t-shirts), and/or to expand artists' non-event library of artwork to a broader audience of social media communities. System 10 also provides tickets and packaging that includes team/venue or band/promoter's Authentic Collection decal and primary ticketing/SeatSafe validated hologram decal.

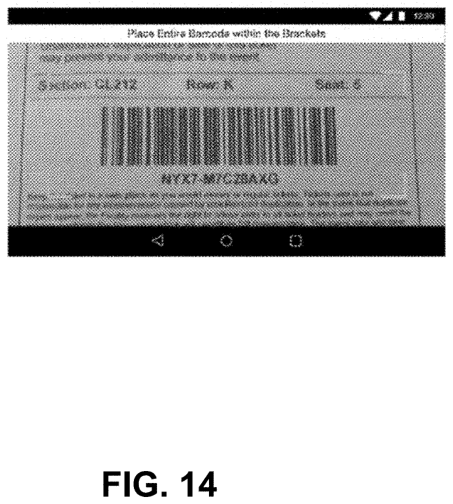

In one embodiment, the data includes scan my printed ticket 20 as shown in FIG. 14, upload my electronic ticket 26, and/or my dog ate my ticket. In another embodiment, the data includes standard souvenir ticket and authentic validated ticket.

In one embodiment, the system 10 additionally includes a payment-module 28 on the user-interface 14 that the user 18 uses to pay for the souvenir 20. In another embodiment, the user-interface 14 executes on a user's 18 mobile phone application, a webpage, and/or team's/act's mobile application.

In one embodiment, the system 10 communicates over a communications network 25, which enables a signal to travel anywhere within system 10 and/or to any other component/system connected to system 10. The communications network 25 is wired and/or wireless, for example. The communications network 25 is local and/or global with respect to system 10, for instance.

System 10 makes it simple for event fans to order custom replica and authentic printed tickets, e.g. souvenir 20, from memorable games and events from the convenience of their smartphone, for example. Souvenir ticket 20 functionality may be invoked on system 10 from the stand-alone SeatSafe mobile application, from the SeatSafe mobile or desktop web page, or an existing mobile application, such as the team's or act's existing mobile application, and/or the like.

In one embodiment, based on the search criteria, the user 18 is presented with options to select from. Otherwise, the customer 18 is asked for the team, event, or venue that a souvenir ticket 20 is desired for. One team, event or venue is selected. Once a team, act, or venue is selected, the user 18 may receive further prompts to select a season or act's tour name. In the case of a team's or act's mobile application this initial form may be omitted.

For example, for professional sports the user will select the year. For an act that has toured multiple years, they will select the tour name or year. For college athletics that have signed up for more than one sport, they will be prompted for both the year and the sport (i.e. football, basketball, baseball).

Most teams, acts, or venues will offer a variety of images that the customer 18 can order. These can be organized into three categories. “Classic Game Tickets” will take the customer to a library of images similar to what was used on printed tickets. “Special Game Moments” will take the customer to a library of images that contain special images, some of which may be specific to the game selected. “Personalized Photo” will take the customer to the library of images on the customer's device. In one embodiment, the customer selects the image that will be used for the souvenir ticket 20, for instance.

“Classic Game Tickets” will take the customer 18 to a library of images on system 10 similar to what was used on the original printed tickets. “Special Game Moments” will take the customer 18 to a library on system 10 of images that contain special images, some of which may be specific to the game selected. In “Select Personalized Photo” the customer 18 selects their choice of image from the devices image library on system 10. Regardless of which library the image is selected from, the selected image is displayed for confirmation.

The customer 18 selects one of three methods to enter and verify their ticket details. The first workflow is “Scan My Printed Ticket” where the customer 18, has in their possession, a paper receipt containing an officially scannable image, such as a barcode or a QR code that was used to admit the fan to the venue. The second workflow is “Upload My Electronic Ticket.” This is used to order tickets directly from the customer's account where the tickets were originally purchased from. The third workflow is “My Dog Ate My ticket.” In this case the fan 18 no longer has a scannable image of the ticket in their possession. In this case, customers 18 can still enter the ticket details manually, and order a genuine souvenir ticket, but the tickets ordered in this workflow will not bear the team's “Authenticated” seal.

In “Scan My Printed Ticket” the customer 18 is taken to a screen on system 10 that shows hashmarks where the customer aligns the barcode within the hashmarks so it is recorded into the order as illustrated in FIG. 14. Behind the scenes the ticket server is queried for the section, row, and seat represented by that ticket. The scanned ticket(s) are summarized on the Ticket Choice screen on system 10. The user 18 has a choice to Scan Another Ticket, or review and finalize the order.

Before the order is finalized, the customer 18 has the option to order either a “Standard Souvenir Ticket” or an “Authentic Validated Ticket.” Both tickets are licensed by the team, act, or venue. The latter also has a validated proof of ownership hologram proving that the owner 18 demonstrated that they bought the original ticket.

In the Upload My Electronic Ticket workflow on system 10 the customer 18 logs into their own account on the server where the tickets were purchased. The user 18 navigates to the existing page that lists tickets that have been previously purchased. The user 18 selects an event that they want to purchase a souvenir ticket 20 for. In this workflow the user 18 avoids the need to scan their used tickets. The ticket server looks up seats that were previously purchased and passes that information to the Souvenir Ticket server 12. At this point, the workflow rejoins the workflow described earlier.

In the “Dog Ate the Ticket” option the customer 18 enters the Section, Row, and Seat manually. Under this option the user 18 can only order the authenticated, but not the validated ticket. Regardless of which of the methods are used, the customer 18 ends up in the Order Review screen on system 10.

The next four screens demonstrate a typical payment process that includes the option to pay for the order by taking a picture of the credit card. The card may also be entered manually. On the last screen the customers 18 finalizes the order and payment method.

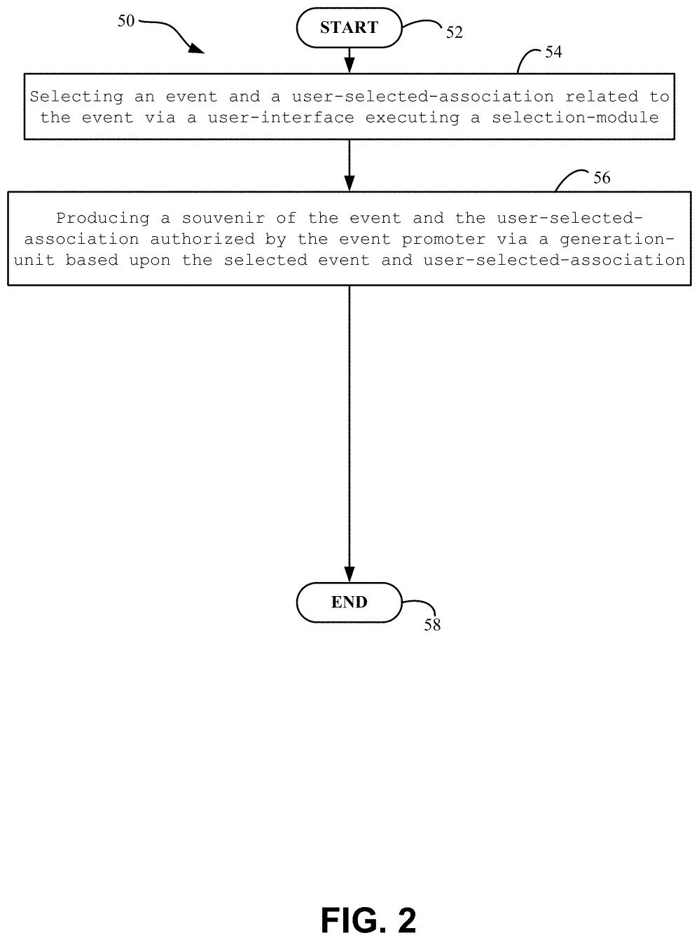

Another aspect is a method of ticketing, which is now described with reference to flowchart 50 of FIG. 2. The method begins at Block 52 and includes selecting an event and a user-selected-association related to the event via a user-interface executing a selection-module at Block 54. The method also includes producing a souvenir of the event and the user-selected-association authorized by the event promoter via a generation-unit based upon the selected event and user-selected-association at Block 56. The method ends at Block 58.

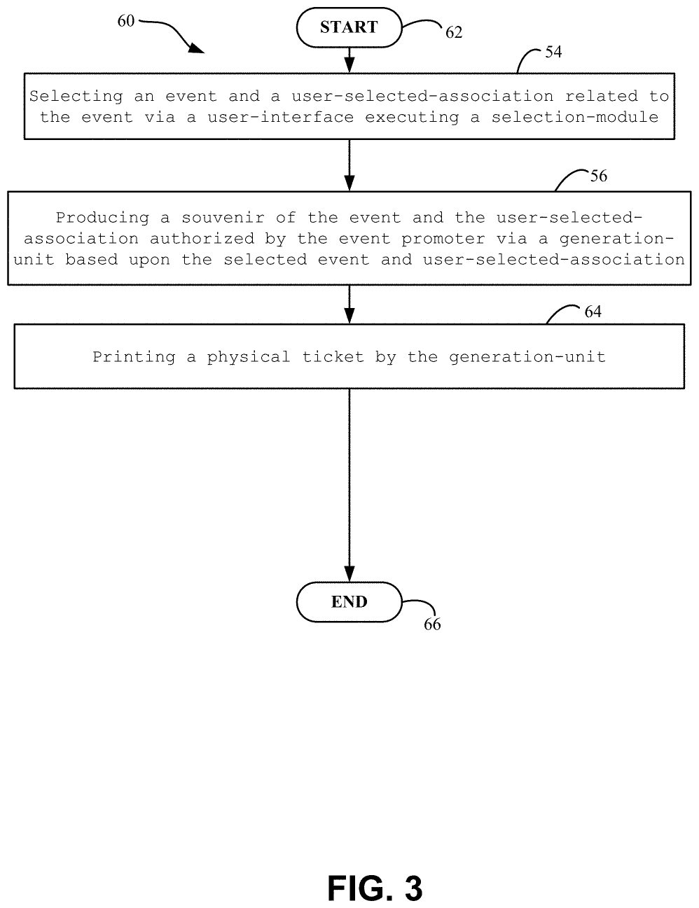

In another method embodiment, which is now described with reference to flowchart 60 of FIG. 3, the method begins at Block 62. The method also includes the steps of FIG. 2 at Blocks 54-56. The method further includes printing a physical ticket by the generation-unit at Block 64. The method ends at Block 66.

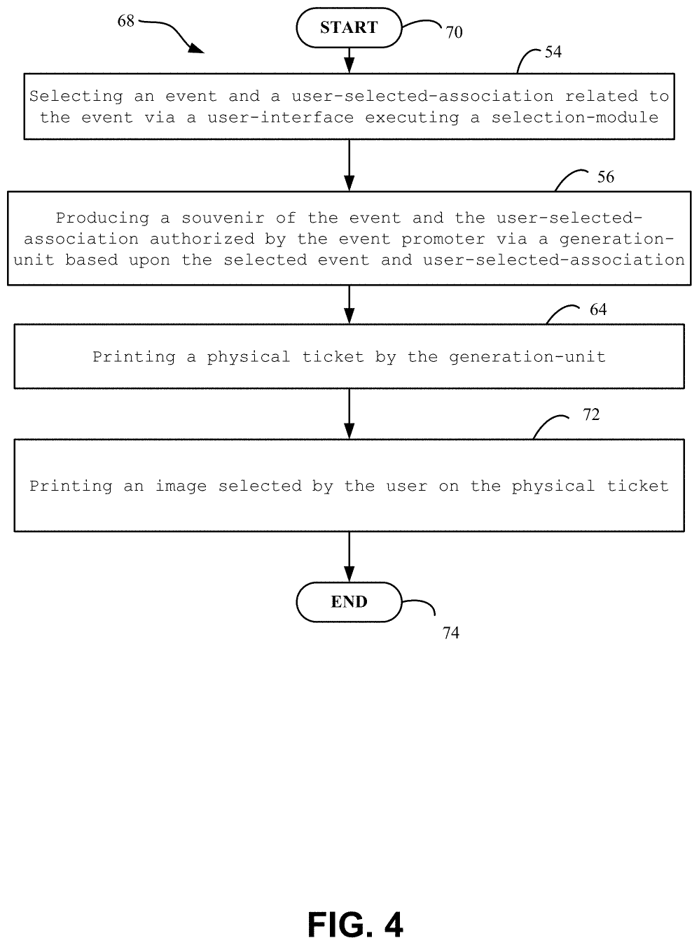

In another method embodiment, which is now described with reference to flowchart 68 of FIG. 4, the method begins at Block 70. The method also includes the steps of FIG. 3 at Blocks 54-56 and 64. The method further includes printing an image selected by the user on the physical ticket at Block 72. The method ends at Block 74.

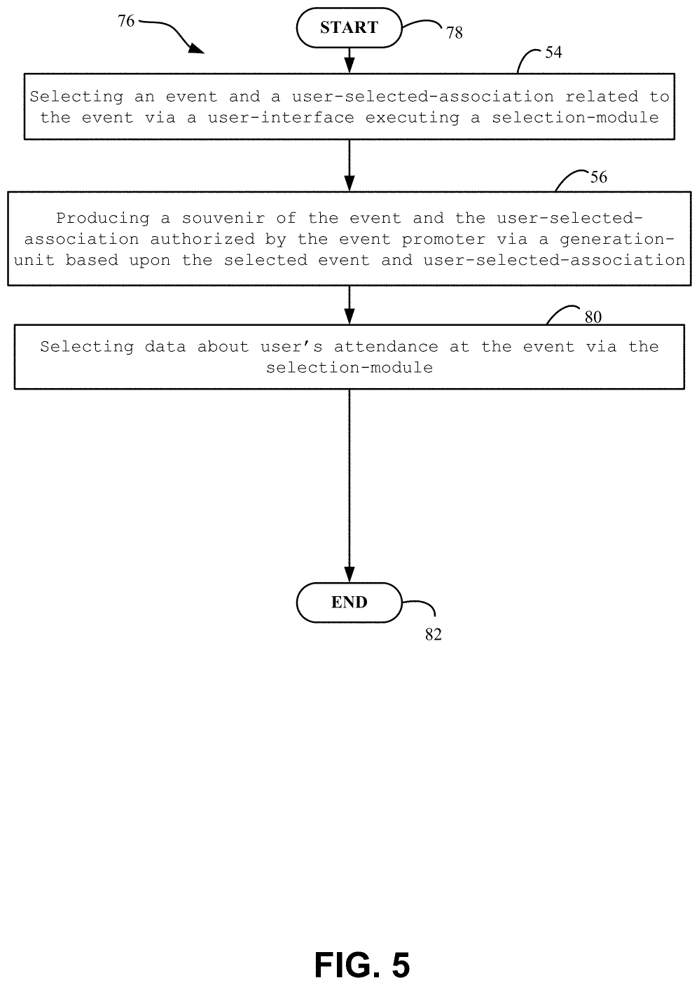

In another method embodiment, which is now described with reference to flowchart 76 of FIG. 5, the method begins at Block 78. The method also includes the steps of FIG. 2 at Blocks 54-56. The method further includes selecting data about user's attendance at the event via the selection-module at Block 80. The method ends at Block 82.

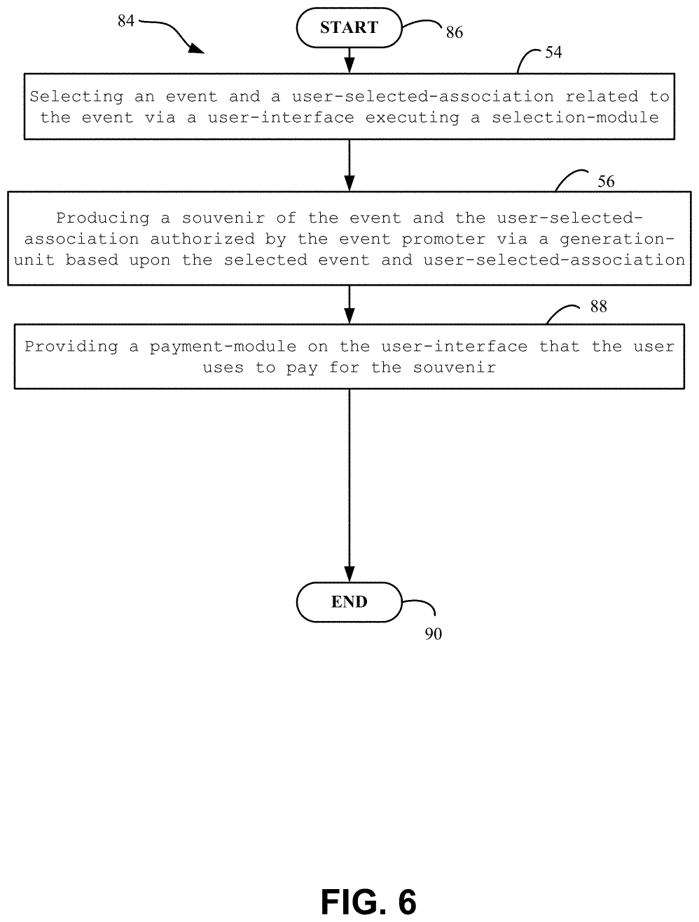

In another method embodiment, which is now described with reference to flowchart 84 of FIG. 6, the method begins at Block 86. The method also includes the steps of FIG. 2 at Blocks 54-56. The method further includes providing a payment-module on the user-interface that the user uses to pay for the souvenir at Block 88. The method ends at Block 90.

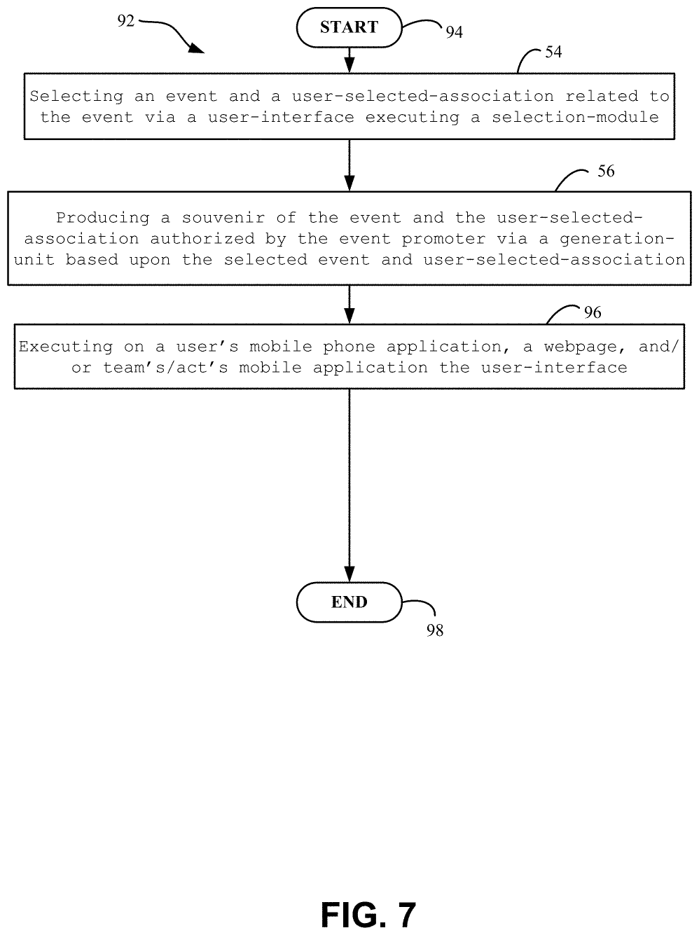

In another method embodiment, which is now described with reference to flowchart 92 of FIG. 7, the method begins at Block 94. The method also includes the steps of FIG. 2 at Blocks 54-56. The method further includes executing on a user's mobile phone application, a webpage, and/or team's/act's mobile application the user-interface at Block 96. The method ends at Block 98.

Another aspect is computer readable program codes coupled to tangible non-transitory media to provide ticketing. In one embodiment, the computer readable program codes are configured to cause the program to select an event and a user-selected-association related to the event via a user-interface 14 executing a selection-module 16; and to produce a souvenir 20 of the event and the user-selected-association authorized by the event promoter 22 via a generation-unit 19 based upon the selected event and user-selected-association.

In one embodiment, the computer readable program codes further provide printing a physical ticket by the generation-unit 19. In another embodiment, the computer readable program codes additionally provide printing an image selected by the user 18 on the physical ticket 24.

In one embodiment, the computer readable program codes also provide selecting data about user's 18 attendance at the event via the selection-module 16. In another embodiment, the computer readable program codes further provides a payment-module 28 on the user-interface 14 that the user 18 uses to pay for the souvenir 20.

In one embodiment, the system 10 will use a social listening algorithm. For example each event / game will have one to several key moments that will surely create “buzz” on a variety of online platforms (from Facebook to ESPN blogs to Instagram, etc.). System 10 will provide a social listening tool that allows for latitude/longitude geographical locations to isolate social conversations that are happening at specific stadiums. Once system 10 picks up these conversations in real time across multiple social platforms, system 10 will force-rank the top ones and allow for consumers 18 to have that respective image to use on their souvenir ticketing product 20.

In another embodiment, system 10 will provide a specialized art product. For instance, system 10 will be linked up with local / national artists, who produce limited edition artwork for specific games / events that are available over system 10.

In another embodiment, system 10 will provide a back of ticket data feed. For example, system 10 will provide a short 2-3 sentence summary of the game and a related box score for sporting (baseball, football, hockey, basketball) events. For concert / music events, system 10 will provide the specific music song set order available for the back of the ticket. This would be a unique feature that would always give the consumer 18 a simple reminder of what happened in that specific game or concert.

In another embodiment, system 10 will provide a mobile souvenir ticketing storage vault. For instance, in all mobile ticketing platforms (Ticketmaster, StubHub, GameTime, etc.) you have a “my tickets” bucket where you can see all your past ticketing purchases. These tickets are in simple digital form with no frills. System 10 will provide the ability to add a personal picture or a special game image to this ticket and have it stored electronically. As such, system 10 will provide easy storage options for the major stadiums in each professional sports league and or concerts. In addition, system 10 can also provide a user 18 a hard copy, e.g. souvenir 20, sent to them.

In another embodiment, system 10 will provide an ability to verify a ticket for authenticity. For example, some games / concerts are special / unique events (perfect games, no hitters, special concerts, etc.). System 10 will have the ability to take an image or scan the barcode, which would then be verified in the ticketing access server for authenticity. The consumer 18 would then get a certified sticker or hologram to signify that it is authentic.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a computer-server;
a user-interface in communication with the computer-server;
a selection-module in communication with the computer-server that enables a user via the user-interface to select an event and a user-selected-association related to the event; and
a generation-unit in communication with the computer-server to produce a souvenir of the event and the user-selected-association authorized by an event promoter.

2. The system of claim 1 wherein the souvenir is a physical ticket that the generation-unit prints.

3. The system of claim 2 wherein the generation-unit prints an image selected by the user on the physical ticket.

4. The system of claim 3 wherein the image includes at least one of classic game tickets, special game moments, and personalized photo.

5. The system of claim 1 wherein the selection-module enables the user to select data about their attendance at the event.

6. The system of claim 5 wherein the data includes at least one of scan my printed ticket, upload my electronic ticket, and my dog ate my ticket.

7. The system of claim 6 wherein the data includes at least one of standard souvenir ticket and authentic validated ticket.

8. The system of claim 1 further comprising a payment-module on the user-interface that the user uses to pay for the souvenir.

9. The system of claim 1 wherein the user-interface executes on at least one of a user's mobile phone application, a webpage, and team's/act's mobile application.

10. A method comprising:
selecting an event and a user-selected-association related to the event via a user-interface executing a selection-module;
producing a souvenir of the event and the user-selected-association authorized by an event promoter via a generation-unit based upon the selected event and user-selected-association.

11. The method of claim 10 further comprising printing a physical ticket by the generation-unit.

12. The method of claim 11 further comprising printing an image selected by the user on the physical ticket.

13. The method of claim 10 further comprising selecting data about user's attendance at the event via the selection-module.

14. The method of claim 10 further comprising providing a payment-module on the user-interface that the user uses to pay for the souvenir.

15. The method of claim 10 further comprising executing on at least one of a user's mobile phone application, a webpage, and team's/act's mobile application the user-interface.

16. A computer program product embodied in a tangible non-transitory storage media comprising: computer readable program codes coupled with the tangible non-transitory storage media, the computer readable program codes configured so that the program executes:
selecting an event and a user-selected-association related to the event via a user-interface executing a selection-module;
producing a souvenir of the event and the user-selected-association authorized by an event promoter via a generation-unit based upon the selected event and user-selected-association.

17. The computer program product of claim 16 further comprising program code configured so that the program executes:
printing a physical ticket by the generation-unit.

18. The computer program product of claim 17 further comprising program code configured so that the program executes:
printing an image selected by the user on the physical ticket.

19. The computer program product of claim 16 further comprising program code configured so that the program executes:
selecting data about user's attendance at the event via the selection-module.

20. The computer program product of claim 16 further comprising program code configured so that the program executes:
providing a payment-module on the user-interface that the user uses to pay for the souvenir.
